(19) United States
(12) Patent Application Publication
(10) Pub. No.: US 2016/0325991 A1
(43) Pub. Date: Nov. 10, 2016

(54) NON-THERMAL PLASMA CLEANING OF DIRTY SYNTHESIS GAS

(71) Applicant: DREXEL UNIVERSITY, Philadelphia, PA (US)

(72) Inventors: Alexander FRIDMAN, Philadelphia, PA (US); Gary NIRENBERG, Hainesport, NJ (US); Alexander RABINOVICH, Cherry Hill, NJ (US); Evan CHERNETS, Philadelphia, PA (US)

(73) Assignee: Drexel University, Philadelphia, PA (US)

(21) Appl. No.: 15/109,244

(22) PCT Filed: Dec. 9, 2014
(86) PCT No.: PCT/US2014/069212

§ 371 Date: Jun. 30, 2016

Related U.S. Application Data
(60) Provisional application No. 61/924,772, filed on Jan. 8, 2014.

(51) Int. Cl. C01B 3/34; H05H 1/48; C01B 3/50; B01J 19/08; B01J 7/00

(52) U.S. Cl. CPC C01B 3/342; B01J 19/088; B01J 7/00; C01B 3/50; H05H 1/48; B01J 2219/0809; B01J 2219/0832; B01J 2219/0869; B01J 2219/0875; B01J 2219/0894; C01B 2203/048; H05H 2001/4695

(57) ABSTRACT

The inventions described herein are directed to technologies for reforming high temperature feedstreams into clean synthesis gas, more particularly, reactor configurations and methods for reforming pyrogas using non-thermal plasmas. One embodiment provides a plasma reactor comprising: (a) a substantially cylindrical reactor wall having a first closed proximal end and a second open distal end, wherein at least a portion of said wall is configured to comprise a first electrode; and (b) a second elongated electrode electrically separated from the first electrode by an electrical insulator, said electric insulator forming either part or all of the first closed end of the reactor or positioned proximate thereto; and configured to be capable of generating and maintaining a glid ing arc plasma discharge within a zone in said reactor.

### CROSS REFERENCE TO RELATED APPLICATIONS

This applications claims priority to U.S. Provisional Patent Application Ser. No. 61/924,772, filed Jan. 8, 2014, the contents of which are incorporated herein by reference in their entirety for all purposes.

### TECHNICAL FIELD

The inventions described herein are directed to technologies for reforming high temperature feedstreams into clean synthesis gas, more particularly, reactor configurations and methods for reforming pyrogas using non-thermal plasmas.

### BACKGROUND

Biomass, municipal wastes, hydrocarbon fuels or coal can be reformed via one or a combination of pyrolysis, combustion and gasification processes. A series of chemical reactions during the course of these processes usually result in the formation of a complex mixture of combustible gases such as CH₄, CO, H₂, unreacted heavy hydrocarbons; tar and a noncombustible gas—(CO₂). A combination of all these gases constitutes what is known as pyrolysis gas or pyrogas.

CₙHₘ+αO₂→H₂+CO+CO₂+H₂O+CₓH_{y}O_{z} (1)

where CₙHₘ represents coal, municipal solid waste or biomass and CₓH_{y} represents methane, ethane, and propane, etc.

The presence of heavy hydrocarbons and tar diminishes the quality of pyrogas from the perspective of its use for power generation or as an intermediate for synthetic fuel production. This drawback therefore necessitates the removal of the unreacted hydrocarbons. An approach to accomplish this task is the use of non-equilibrium gliding arc plasma for the chemical reformation of pyrogas into synthesis gas or syngas. Non-equilibrium gliding arc plasma reforming is a fuel reforming process, which eliminates the need for catalysts. Catalytic partial oxidation has been known to have extensive drawbacks such as high cost, large size and significant carbon footprint. Gliding arc plasma, on the other hand, is characterized by smaller reactors, fast start-up time, higher efficiency and low electrical energy cost to produce plasma; about 2%-5% of total chemical energy produced within the system.

The reforming reactions considered for pyrogas reforming are partial oxidation reaction, steam reforming reaction and dry CO₂ reforming reaction. These main reforming reactions produce hydrogen rich synthesis gas which can be used for power generation, utilized for fuel cells to produce electricity and as a building block for production of synthetic fuels via the Fischer Tropsch process.

Pyrogas that coming out of gasifier already has a temperature 600-900° C. Therefore a gliding arc plasma serves only as a resource for active species and radicals such as O and OH which are necessary to stimulate the desired chemical reactions. Many researchers have done extensive work on reforming hydrocarbons (such as methane, ethane, propane, and diesel) individually taking different approaches in the reforming methods adopted. Gliding arc discharge has successfully been used in fuel reforming of hydrocarbons such as methane, ethane, diesel, gasoline, biofuels etc. Gliding arc plasma has also found applications in hydrogen sulfide (H₂S) dissociation, volatile organic compounds (VOCs) decomposition and carbon dioxide (CO₂) dissociation.

The high temperatures associated with this incoming pyrogas provide significant challenges in identifying materials for use in reactors that are capable of handling the aggressive environments posed by this feedstream. The main problem is that most of electrical insulators are losing their dielectric properties at this level of temperatures. Moreover, the surfaces of the electrical insulators operated in high temperature dirty pyrogas are soon covered by soot thus providing conditions for discharge breakdown.

The present invention is directed to addressing at least some of these problems.

### SUMMARY

Certain embodiments of the present invention provide plasma reactors for treating feedstocks at high temperature, each reactor comprising: (a) a substantially cylindrical reactor wall having a first closed proximal end and a second open distal end, wherein at least a portion of said wall is configured to comprise a first electrode; (b) a second elongated electrode electrically separated from the first electrode by an electrical insulator, said electric insulator forming either part or all of the first closed end of the reactor or positioned proximate thereto; (c) said first and second electrodes further separated by a gap and capable of generating and maintaining a gliding arc plasma discharge within a zone in said reactor upon application of an electric potential difference between the first and second electrodes; (d) said cylindrical wall having at least one feedstock injection portal, said feedstock injection portal capable of sustainably contacting an organic feedstock at the high temperature and configured to direct said feedstock tangentially into the plasma zone of said reactor; and (e) said cylindrical wall also having at least one air injection portal, said air injection portal positioned adjacent to the electrical insulator, said air injection portal configured to direct air tangentially into said reactor so as to shield the electrical insulator from the high temperature of the feedstock or plasma generated within the reactor, and to generate a vortex flow in the reactor and out the second open end.

Other embodiments provide methods for operating these plasma reactors, each method comprising: (a) providing air into the reactor through the air inlet portal at a rate sufficient to maintain the insulator at a temperature below a pre-defined threshold temperature, for example about 500° F. (about 260° C.); (b) providing feedstock tangentially into the plasma zone through the feedstock inlet portal; and (c) initiating a gliding arc plasma in the plasma zone between the first and second electrodes by the application of an electric potential difference across the first and second electrodes

Still other embodiments of the present invention also provide additional types of plasma reactors for treating feedstocks at high temperature, each reactor comprising: (a) a substantially cylindrical outer shell having proximal and distal ends and configured to be positionable in-line to a tubular exhaust manifold, with the proximal end of the shell configured to be adjacent to and to receive the high temperature feedstock incoming from the tubular exhaust manifold; (b) a cupped first electrode having a open distal end facing away from the exhaust manifold, said first electrode positioned at or near the proximal end of the outer shell; (c) a substantially cylindrical second electrode having proximal and distal ends, the proximal end of the second electrode positioned adjacent to but separated from the distal end of the first electrode by a gap, said electrodes and gap configured to be capable of generating and maintaining a gliding arc plasma discharge within a plasma zone in said reactor upon application of an electric potential difference between the first and second electrodes; (d) the first electrode being physically attached to the proximal end of the outer shell by a first solid flange, said flange providing electrical communication between the first electrode and the outer shell and having a plurality of channels passing therethrough, said channels configured to direct the high temperature feedstock incoming from the exhaust manifold tangentially into the plasma zone; (e) the distal end of the second electrode physically attached the distal end of the outer shell by a second solid flange, said second flange comprising an electrical insulator capable of electrically isolating the second electrode from the outer shell; and (f) the outer shell, the second electrode, and the first and second flanges defining a substantially cylindrical annulus therebetween.

Other embodiments provide for methods of operating the same comprising: (a) providing cooling airflow through the cylindrical annulus; (b) providing the feedstock tangentially into the plasma zone through the feedstock channels; and (c) initiating a gliding arc plasma in the plasma zone between the first and second electrodes by the application of an electric potential difference across the first and second electrodes.

Other embodiments provide for still additional flow-through plasma reactors for treating high temperature feedstocks, each flow-through reactor comprising: (a) a reactor conduit through which a high temperature feedstock passes; and (b) at least two non-thermal plasma reactors, each reactor comprising at least one inlet circumferential gas flow inlet apparatus, an electrode, and a flow restricted exit portal; said non-thermal plasma reactors configured to eject a jet of non-thermal plasma, when energized, into said conduit so as to contact the high temperature feedstock with sufficient energy to remove heavy hydrocarbons and particulates from the passing high temperature feedstock. In related embodiments, the at least two non-thermal plasma reactors are configured to work in tandem with one another such that a first reactor electrode can be maintained at a high voltage electric potential relative to a second reactor electrode, said first and second reactor electrodes forming an electrode pair capable of maintaining a non-thermal plasma discharge between the first and second reactor electrodes. Additionally or alternatively, the flow-through plasma reactor may further comprise: (a) a blower positioned within the reactor conduit downstream from the positions into which the at least two non-thermal plasma reactors are directed; and (b) at least one return conduit in fluid communication with the reaction conduit at a position downstream from the blower and at least one inlet apparatus of at least one non-thermal plasma reactors; such that the blower, when operating, reduces the pressure of the feedstock in a volume of the conduit between the at least two non-thermal plasma reactors and the blower, said reduced pressure causing gas to be redirected from the position downstream from the blower to the at least one inlet apparatus of at least one non-thermal plasma reactors.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In addition, the drawings are not necessarily drawn to scale. In the drawings:

FIG. 1 illustrates one embodiment of a high temperature gliding arc plasma reformer with sideway gas injection.

FIG. 2 illustrates another exemplary embodiment of a configuration for cleaning by a flat gliding arc.

FIG. 3 illustrates another embodiment of a high temperature plasma reformer with additional fuel injection.

FIG. 4 illustrates one embodiment of an air cooled, in-line gas reformer

FIG. 5 illustrates one embodiment of a high temperature plasma reformer with direct gas injection.

FIG. 6 illustrates one exemplary embodiment of a reactor and method of cleaning dirty pyrogas, wherein the dirty pyrogas is injected tangentially into a gliding arc plasmatron.

FIG. 7 illustrates another exemplary embodiment of a configuration for cleaning dirty pyrogas by injecting high temperature gliding arc plasmatron jets into a pyrogas stream.

FIG. 8 illustrates yet another exemplary embodiment of a configuration for cleaning dirty pyrogas by using high temperature jets generated at a double-jet plasmatron.

FIG. 9 illustrates still another exemplary embodiment of a configuration for cleaning dirty pyrogas by recirculating clean synthesis gas into a gliding arc plasmatron.

FIG. 10A and FIG. 10B show the V-A and power characteristics of plasma reformer described in Example 1.

### DETAILED DESCRIPTION OF ILLUSTRATIVE EMBODIMENTS

The present invention is directed to cleaning “dirty” synthesis gas (“syngas”), also known as pyrogas, where “dirty” refers to the undesirable presence of heavy hydrocarbons. The invention is further directed to reforming this high temperature gas deriving from biomass, coal and municipal wastes gasification, and the special design of the non equilibrium gliding arc plasma reformer allows for this reforming.

The present invention may be understood more readily by reference to the following description taken in connection with the accompanying Figures and Examples, all of which form a part of this disclosure. It is to be understood that this invention is not limited to the specific products, methods, conditions or parameters described or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using).

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

It is to be appreciated that certain features of the invention which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

The transitional terms “comprising,” “consisting essentially of,” and “consisting” are intended to connote their generally in accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps “and those that do not materially affect the basic and novel characteristic(s)” of the claimed invention. Embodiments described in terms of the phrase “comprising” (or its equivalents), also provide, as embodiments, those which are independently described in terms of “consisting of” and “consisting essentially of” For those embodiments provided in terms of “consisting essentially of,” the basic and novel characteristic(s) is the operability of the methods (or the systems used in such methods or the compositions derived therefrom) to operate plasma reactors continuously at temperatures in a range of from about 600° C. to about 900° C.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

Throughout this specification, words are to be afforded their normal meaning, as would be understood by those skilled in the relevant art. However, so as to avoid misunderstanding, the meanings of certain terms will be specifically defined or clarified.

### Tangentially Configured Reactors

Certain embodiments of the present invention include plasma reactors for treating feedstocks at high temperature, each reactor comprising (a) a substantially cylindrical reactor wall having a first closed proximal end and a second open distal end, wherein at least a portion of said wall is configured to comprise a first electrode; (b) a second elongated electrode positioned within the reactor wall, electrically separated from the first electrode by an electrical insulator, said electric insulator forming either part or all of the first closed end of the reactor or positioned proximate thereto; (c) said first and second electrodes further separated by a gap and capable of generating and maintaining a gliding arc plasma discharge within a zone in said reactor upon application of an electric potential difference between the first and second electrodes; (d) said cylindrical wall having at least one feedstock injection portal, said feedstock injection portal capable of sustainably contacting an organic feedstock at the high temperature and configured to direct said feedstock tangentially into the plasma zone of said reactor; and (e) said cylindrical wall also having at least one air injection portal, said air injection portal positioned adjacent to the electrical insulator, said air injection portal configured to direct air tangentially into said reactor so as to shield the electrical insulator from the high temperature of the feedstock or plasma generated within the reactor, and to generate a vortex flow in the reactor and out the second open end. In some additional embodiments, the reactor further comprises a post-plasma zone positioned distally (downstream) from the plasma zone.

As used herein, the term “high temperature feedstocks” or “feedstocks at high temperatures” include those feedstocks which are delivered to the plasma reactors at high temperatures, typically at least 600° C., and often in a range of from about 600° C. to about 900° C. Such feed gases include so-called pyrogas,” which itself is recognized as a product of biomass, municipal wastes, or coal-gasification process that usually contains hydrogen, carbon monoxide, carbon dioxide, water, unreacted light and heavy hydrocarbons, and tar. The ability to accept and operate plasma reactors at these elevated temperatures is often necessary to process these streams without the condensation of contained tars or other high boiling fractions in the conduits or channels within the reactors. The designs of conventional non-thermal plasma reactors are incompatible with operating at these elevated temperatures, generally because of temperature limits on the insulating materials, and only by the modifications described herein can such feedstreams be processed without deleterious consequences (e.g., plugging, insulator failure, reactor shorting).

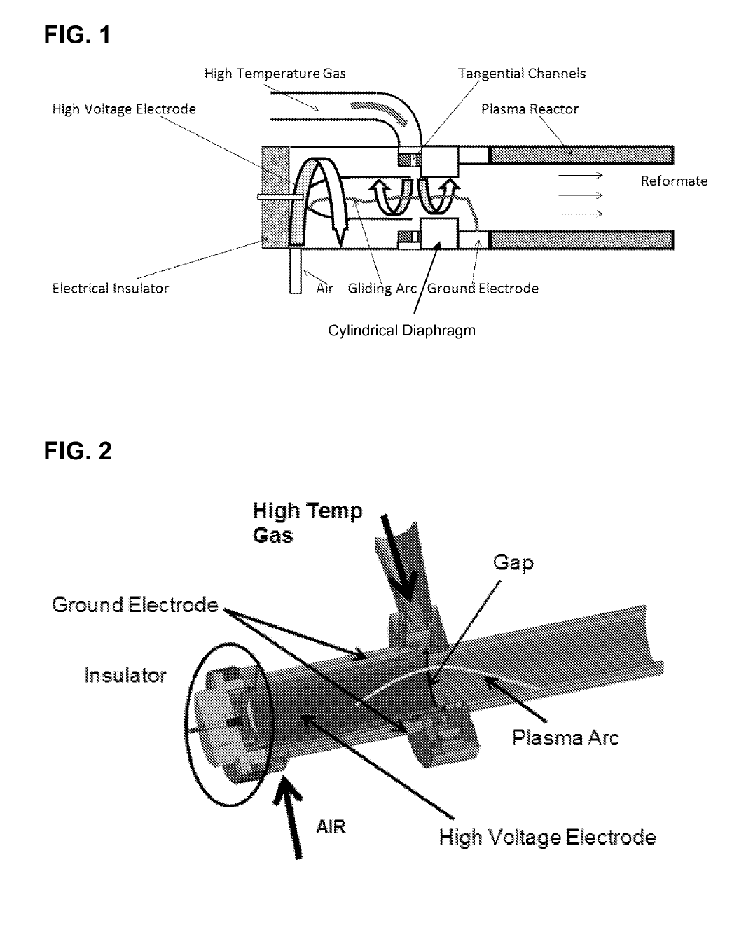

FIG. 1 and FIG. 2 show two such configurations of the immediately previous descriptions. In each of these configurations, high temperature gases are variously injected into a plasma zone between the gaps of the first and second electrodes. While not necessarily limited to the specific electrode polarities, for safety sake, the first, outer electrode (included in the reactor shell) is best configured as the ground electrode while the second, inner electrode is configured as the high voltage electrode. In such arrangements, the two electrodes are insulated from one another by electrical insulators positioned away from the electrode gaps, and protected by cooling air supplied by judiciously placed air injection portals. In FIG. 1, this air injection portal is shown to provide air, oxygen, or both that buffers the end placed insulator from the heat of both the incoming gas and the plasma associated with its treatment, said air, oxygen, or both encircling the second, internal electrode and evenually acting to react with the fuel in the plasma zone. A similar configuration is shown in FIG. 2. In both cases, the electrical insulator is removed from the high temperature zone and protected by injection of cold air. Air that is injected tangentially in the direction of general vortex merge with the high temperature gas inside the plasma zone and participates in the reforming of hydrocarbons as an oxidizer for partial oxidation reaction.

As shown in FIG. 1, in some embodiments, the insulator forms the first closed end of the reactor shell and said second electrode penetrating therethrough into the volume of the reactor shell and connected with a high voltage power supply. In some embodiments, the electric insulator comprises a perfluoropolymer, preferably polytetrafluoroethyle (PTFE) or other perfluorinated polymers known in the art. These electrical insulators may also optionally contain structually reinforcing materials, for example, glass fibers or fillers. Glass filled PTFE is a preferred material for this purpose for its cost and chemical stability. FIG. 1 shows another optional features useful in some designs—i.e., a cylindrical diaphragm positioned within the reactor such that the at least one feedstock injection portal is positioned in the gap between the first and second electrodes and distally in relation to the at least one feedstock injection portal (i.e., the feedstock injection portal is positioned between the diaphragm and the closed end of the reactor). This diaphragm acts to promote reverse vortex mixing within the plasma zone, providing more effective treatment of the gas before its exit from the reactor.

FIG. 2 shows another arrangement of the two electrodes, in which the second electrode is configured as a concentric inner sleeve or shell, within the substantially cylindrical reactor wall (first electrode).

In each of these designs, the at least one feedstock injection portal configured to direct said feedstock tangentially into said reactor between the gap between the first and second electrodes. This provides, in use, that the high temperature gas (e.g., pyrogas or exhaust gas from gasifier containing H₂, CO, CO₂, N₂, H₂O as well as unreacted light and heavy hydrocarbon) is injected through one or more tangential channels into the gap between two electrodes and create vortex. Gliding arc discharge that initiates between high voltage and ground electrodes rotates by vortex and stretches both ways thus creating plasma zone for reforming unreacted hydrocarbons into syngas. In addition to directing the air into the reactor so as to generate vortex flow and direct the product out of the reactor, this injection of air, oxygen, or both can be used to correct or modify the ratio of O/C in the reactor. While the specific desired O/C ratio depends on the intended application, in some embodiments, this O/C ratio is preferably in a range of from about 1 to about 1.6, and more preferably in a range of from about 1 to about 1.2. Produced clean syngas can be efficiently used for power generation in turbines, internal combustion (ICE) engines, (solid oxide) fuel cells or for synthetic liquid fuel production by the Fisher-Tropsch process.

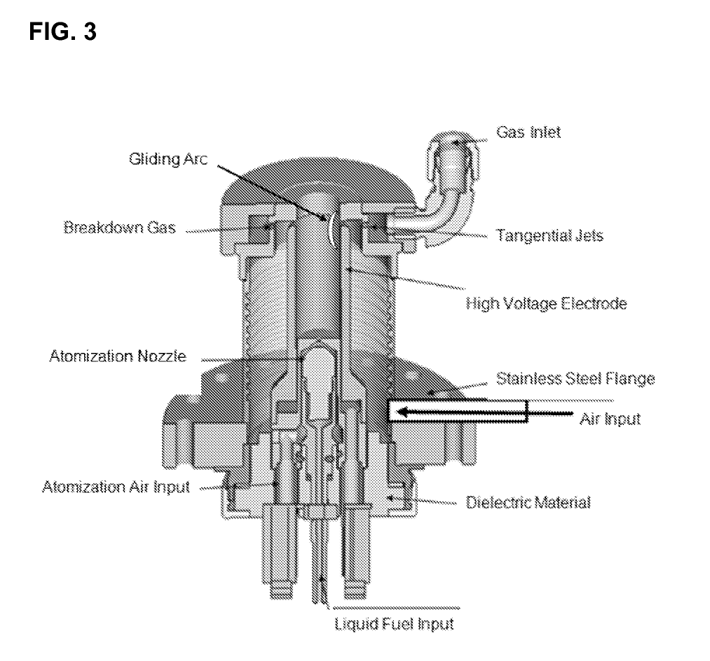

Yet another design having the features described above is shown in FIG. 3, in which the high voltage electrode is equipped with fuel nozzle and atomization air. In certain embodiments, the plasma reactor further comprises a fuel nozzle, an air atomizer, or both a fuel nozzle and air atomizer in fluid communication with the first closed proximal end, capable of injecting fuel, air, or both fuel and air axially into the reaction chamber. Fuel such as gasoline, diesel or JP8 may be atomized to tiny droplets with size 10-30 micron and reformed to syngas in the plasma zone. This type of reformer is convenient when the high temperature gas (for example, exhaust gas from ICE engine or solid oxide fuel cells) contains CO₂, H₂O, N₂ and 0₂ but not hydrocarbons. In this case additional fuel may be added for syngas production.

Critical to the designs shown in FIG. 3 is the presence and positioning of the at least one air input channel proximate to the dielectric insulating material. In early designs where these features were not present, while the reactors were able to operate for short periods, eventually the surface of insulator (in these experiments, PTFE insulators were used) became covered by soot followed by arcing and melting of PTFE. Replacing the PTFE with glass filled PTFE provided no better results. Only by installing the additional tangential air cooling proximate to the PTFE surface so as to inject cooling air were the reactors able to provide long term (months) uninterrupted performance. The addition of the tangential cooling air input served a dual purpose: in addition to cooling PTFE surface (so as to maintain it to a temperature below about 500° F. (about 260° C.) for longer life performance, the air also made it possible to correct produced syngas composition if necessary or as desired.

In addition to the reactor configurations themselves, the present invention includes those methods for treating the high temperature gases by the reactors so-far described. These embodiments includes methods of operating the plasma reactors described herein, each method comprising: (a) providing air into the reactor through the air inlet portal at a rate sufficient to maintain the insulator at a temperature below a pre-defined threshold temperature, for example about 500° F. (about 260° C.); (b) providing feedstock tangentially into the plasma zone through the feedstock inlet portal; and (c) initiating a gliding arc plasma in the plasma zone between the first and second electrodes by the application of an electric potential difference across the first and second electrodes. Again, as described above, while in principle the methods do not depend on the particular polarity of the first and second electrodes, for safety sake, it is preferred that the first electrode is a ground electrode and the second electrode is a high voltage electrode.

The operating parameters for gliding arc discharge reactors are generally well recognized, and despite the higher temperatures of the incoming feedstocks (e.g., typically in a range of from about 600° C. to about 900° C.), may be use such operating parameters. That is, in preferred embodiments, the gliding arc plasma reactors used in the present invention are typically operated in a range of from about 800 V to about 10 kV, preferably in a range of from about 1000 V to about 1500 V, and an average current in a range of from about 2 to about 50 A, preferably in a range of from about 5 to about 30 A, or from about 10 to about 30 A. In general, this provides an energy consumption less than about 1 kW-h/m³, preferably less than about 0.5 kW-h/m³, or less than about 0.1 kW-h/m³.

### Flow-Through Reactors—Modified Configurations

The reactors and methods described to this point may be described as tangentially configured reactors, to the extent that the high temperature gas or pyrogas is introduced into a lateral wall of the reactor. In other designs, the reactors may best be described as flow-through reactors, in that the incoming high temperature gases pass through the reactors, entering one end and exiting an opposite end. To some extent, this construct may be seen as artificial, since in some cases, the incoming flow of hot gases in some of these flow-through reactors are directed through the entering end so as to enter the plasma zone tangentially. But in these designs, the reactor may be added directly in-line with a gas exhaust manifold, and so may be more easily visualized in terms of a flow-through reactor.

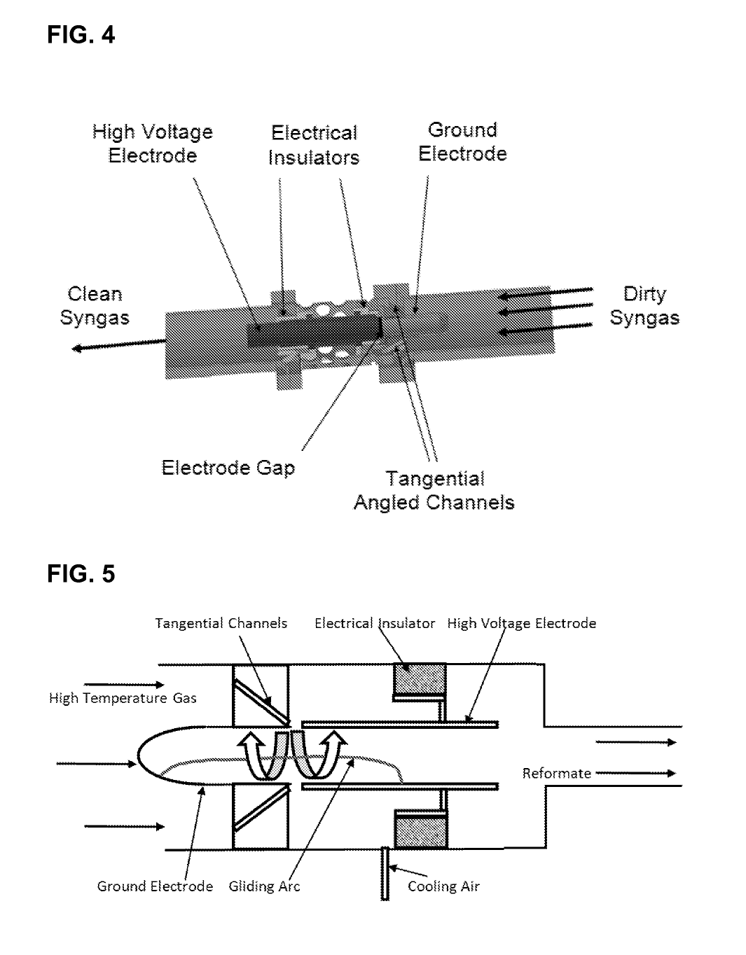

Some such embodiments include plasma reactors for treating feedstocks at high temperature, each reactor comprising: (a) a substantially cylindrical outer shell having proximal and distal ends and configured to be positionable in-line to a tubular exhaust manifold, with the proximal end of the shell configured to be adjacent to and to receive the high temperature feedstock incoming from the tubular exhaust manifold; (b) a cupped first electrode having a open distal end facing away from the exhaust manifold, said first electrode positioned at or near the proximal end of the outer shell (such that the closed end of the cup is heated by the incoming high temperature gas); (c) a substantially cylindrical second electrode having proximal and distal ends, the proximal end of the second electrode positioned adjacent to but separated from the distal end of the first electrode by a gap, said electrodes and gap configured to be capable of generating and maintaining a gliding arc plasma discharge within a plasma zone in said reactor upon application of an electric potential difference between the first and second electrodes; (d) the first electrode being physically attached to the proximal end of the outer shell by a first solid flange, said flange providing electrical communication between the first electrode and the outer shell and having a plurality of channels passing therethrough, said channels configured to direct the high temperature feedstock incoming from the exhaust manifold tangentially into the plasma zone; (e) the distal end of the second electrode physically attached the distal end of the outer shell by a second solid flange, said second flange comprising an electrical insulator capable of electrically isolating the second electrode from the outer shell; and (f) the outer shell, the second electrode, and the first and second flanges defining a substantially cylindrical annulus therebetween. FIGS. 4-6 are exemplary illustrations reactors that may contain these features.

In some of these embodiments, the reactors further comprise a third flange, said third flange comprising an electric insulator and attaching and electrically insulating the proximal end of the second electrode and the outer shell. See, e.g., FIG. 4.

In preferred embodiments, the high temperature feedgas has an incoming temperature in a range of from about 600° to about 900° C., and each reactor comprises materials of construction in a configuration capable of sustained contact between the reactor and the feedgas for at least 1000 consecutive hours. Obviously, longer operating windows are preferred and the skilled artisan would be able to combine the design configurations described herein with an understanding of materials to accomplish this task.

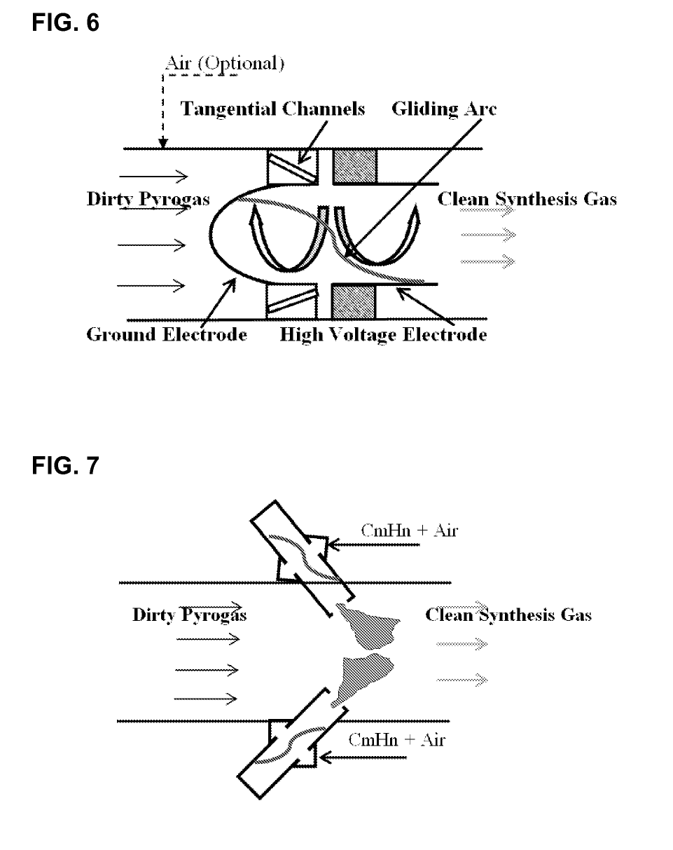

In certain of these embodiments, the substantially cylindrical outer shell comprises ventilation holes. This is exemplified in FIG. 4. In such embodiments, the high voltage inner electrode is cooled either by external forced air or natural convection through these holes, while holes are sized such that the outer grounded shell physically shields the operator from electrical shock. Note that the cup first electrode is positioned with its open distal end facing away from the incoming hot gas of the exhaust manifold, and the hot gas is directed through the angled tangential channels into the plasma zone. These angled tangential channels also appear, and are more easily seen, in FIG. 5 and FIG. 6.

FIG. 5 and FIG. 6 each illustrate embodiments in which the outer, first electrode is a solid wall, having at least one air inlet configured to be capable of providing cooling to the substantially cylindrical annulus upon delivery of air thereto. The incoming cool air protects the electrical insulators from the incoming hot gas/pyrogas such that the surface of the insulator can be maintained to less than about 500° F. (about 260° C.), thereby allowing the sustained use of PTFE or filled composited thereof (e.g., glass-filled PTFE) as the electrical insulator in the second flange. The cooling air also acts as an oxidizer in the plasma zone as it passes therethrough and exits the cylindrical annulus through the electrode gap.

As shown in FIG. 4, in the illustrations of FIG. 5 and FIG. 6, the cupped first electrode is positioned with its open distal end facing away from the incoming hot gas of the exhaust manifold, and the hot gas is directed through the angled tangential channels into the plasma zone. In each case, the heat of the incoming gas, configuration of the cupped electrode and first flange, and the diameters of the angled tangential channels as arranged so as to prevent the condensation of or plugging by the tars, particulates, or heavy hydrocarbons of the pyrogas within these tangential channels. These tangential channels are configured to direct the incoming hot gas into gap between high voltage and ground electrodes. In these embodiments, the pyrogas maintains its fluidity so as to provide an intimate contact between gliding arc and pyrogas. Air, oxygen, or a mixture of both can be added to pyrogas in order to increase gas temperature or to provide partial oxidation of remaining unreacted hydrocarbons.

The methods of operating such reactors should be apparent, but for the sake of completeness with be described herein, where each method comprises: (a) providing cooling airflow through the cylindrical annulus; (b) providing the feedstock tangentially into the plasma zone through the feedstock channels; and (c) initiating a gliding arc plasma in the plasma zone between the first and second electrodes by the application of an electric potential difference across the first and second electrodes. In certain of these embodiments, the feedstock further comprising hydrogen, carbon monoxide, carbon dioxide, steam, light and heavy hydrocarbons, tar, air, oxygen, nitrogen, or a combination thereof

### Flow-Through Reactors

Other flow-through designs are also available, where the pyrogas or other high temperature gas passes unimpeded through the reactor, without passing through flange through-holes. Such designs include this illustrated in FIGS. 7 to 9.

In certain of these embodiments, a flow-through plasma reactor for treating high temperature feedstocks is presented here, each flow-through reactor comprising: (a) an electrically grounded reactor conduit through which a high temperature feedstock passes; and (b) at least two non-thermal plasma [torch] reactors, each electrically insulated from the central reaction chamber, and each non-thermal plasma reactor comprising at least one inlet circumferential gas flow inlet apparatus, a pair of electrodes capable of generating a gliding arc plasma within the non-thermal plasma reactor, and a flow restricted exit portal; said non-thermal plasma reactors configured to eject a jet of non-thermal plasma, when energized, into said conduit so as to contact the high temperature feedstock with sufficient energy to remove heavy hydrocarbons and particulates from the passing high temperature feedstock. Each non-thermal plasma [torch] reactor is independently fed with mixtures of hydrocarbons and air, preferably tangentially, so as to create a vortex in the non-thermal plasma [torch] reactor.

FIG. 7 shows one such arrangement in which at least two gliding arc plasma reactors positioned outside the exhaust tube with dirty pyrogas. At the same time the nozzles of these plasma reactors are inserted into the exhaust tube the way that provide maximal contact of pyrogas with high temperature plasma jets. The plasma gas in this case could be mixture of hydrocarbon fuel (such as natural gas, diesel, hydrocarbon wastes, etc.) with air at O/C ratio in a range of about 1 to about 1.8, depending on the nature of the transformation of the pyrogas desired. At this ratio exhaust gas coming out of plasma reactor has temperature in a range of about 1200° C. to about 1600° C. and consists mainly of H₂, CO and N₂. At these temperature and composition the plasma jets will provide a very efficient cleanup of dirty pyrogas.

In other embodiments, the flow-through plasma reactor may comprise (a) an electrically grounded reactor conduit through which a high temperature feedstock passes; and (b) at least two non-thermal plasma [torch] reactors, each electrically insulated from the central reaction chamber, and each non-thermal plasma reactor comprising (i) an electrode; (ii) at least one circumferential inlet gas flow apparatus connected in fluidic communication to a first reactor; and (iii) a flow restricted exit portal; the at least one inlet circumferential flow apparatus and flow restricted exit portal of the first reactor configured to provide mixing of a gas within the first reactor upon introduction of said gas through the at least one circumferential inlet gas flow apparatus into said first reactor; and the at least one inlet circumferential flow apparatus and flow restricted exit portal of a second reactor configured to provide mixing of a gas within the second reactor upon introduction of said gas through the at least one circumferential inlet gas flow apparatus into said second reactor; wherein the flow restricted exit portal of each reactor is connected in fluidic communication with the central reaction chamber; wherein electrodes of the first and second reactors are configured as a first and second electrode, respectively, so as to sustain a high voltage electrical potential between the first and second electrodes; and wherein the non-thermal plasma reactor is configured to sustain a non-thermal plasma between the first and second electrodes when ignited. In certain of these embodiments, each reactor further comprises an ignition electrode. In other embodiments, the flow restricted exit portal of each reactor is adapted to act as an ignition electrode. Such tandem configurations are the subject of another U.S. Patent Application (U.S. application Ser. No. 13/933,460) directed to the use of these multiplexed reactors, the contents of which are incorporated by reference herein in its entirety.

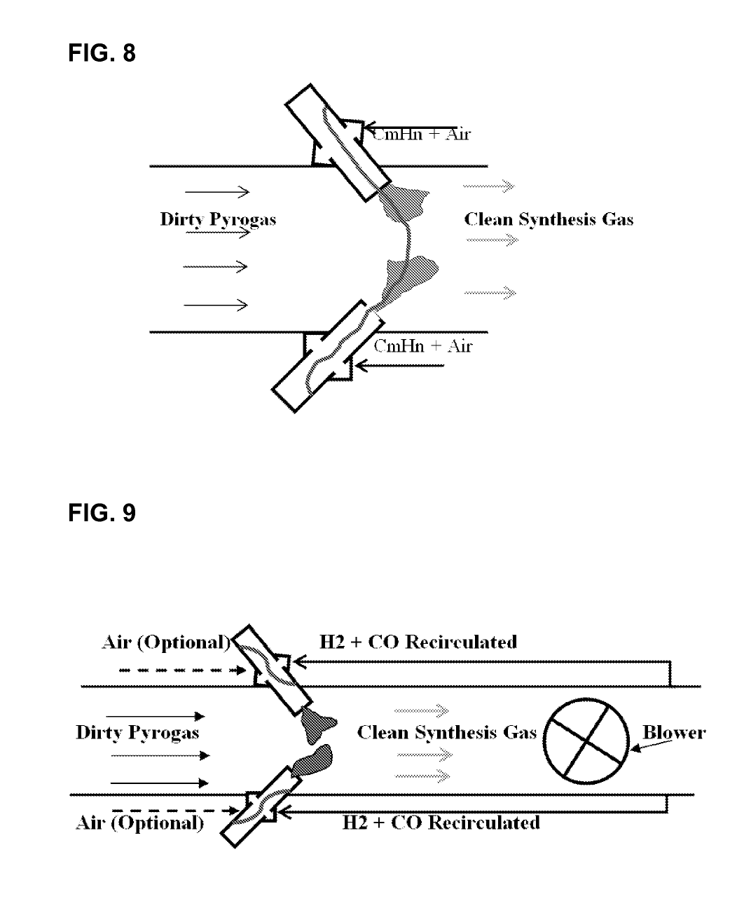

FIG. 8 shows one such configuration, in which a two jet gliding arc plasma system having one joint extended arc is used to clean or react with the passing pyrogas. In this case one of the plasmatrons serves as a high voltage electrode and another as a ground electrode. Only one power supply is required in this case. Application of a two-jet gliding arc plasma system is a convenient way of scaling up the process and minimizing capital cost.

Yet other embodiments of these flow-through systems comprise the use of down-stream blower fans, or blowers. In such embodiments, the flow-through plasma reactor further comprises: (a) a blower positioned within the reactor conduit downstream from the positions into which the at least two non-thermal plasma reactors are directed; and (b) at least one return conduit in fluid communication with the reaction conduit at a position downstream from the blower and at least one inlet apparatus of at least one non-thermal plasma reactors; such that the blower, when operating, reduces the pressure of the feedstock in a volume of the conduit between the at least two non-thermal plasma reactors and the blower, said reduced pressure causing gas to be redirected from the position downstream from the blower to the at least one inlet apparatus of at least one non-thermal plasma reactors. This concept is illustrated in FIG. 9, where the blower pulls the intermediate volume of gas between the plasma torches and the blower and forces it further downstream, thereby reducing the relative pressure in the intermediate volume of gas and raising the pressure downstream of the blower. The effect of this pressure imbalance is to recirculate some of the downstream clean synthesis gas back into the at least one non-thermal plasma reactor, providing the fuel for that non-thermal plasma reactor. Additional air/oxygen could be added as necessary to plasma gas to increase temperature and size of plasma jet.

Additional methods of operating these flow-through plasma (torch) reactors comprise: (a) passing a high temperature feedstock stream through the reactor; and (b) providing sufficient energy to the at least two non-thermal plasma reactors to provide non-thermal plasma jets into the high temperature feedstock stream. Where one or more blowers are part of configured embodiments, the methods comprise: (a) passing a high temperature feedstock stream through the reactor; (b) providing sufficient energy to the at least two non-thermal plasma reactors to provide non-thermal plasma jets into the high temperature feedstock stream; and (c) energizing the blower to blow downstream from the plasma jets so as to reduce the pressure of the feedstock in a volume of the conduit between the at least two non-thermal plasma reactors and the blower, so as to redirect a portion of the gas downstream from the blower to the at least one inlet apparatus of at least one non-thermal plasma reactors.

The following listing of embodiments is intended to complement, rather than displace or supersede, the previous descriptions.

Embodiment 1. A plasma reactor for treating feedstocks at high temperature, said reactor comprising: (a) a substantially cylindrical reactor wall having a first closed proximal end and a second open distal end, wherein at least a portion of said wall is configured to comprise a first electrode; (b) a second elongated electrode positioned within the reactor wall, electrically separated from the first electrode by an electrical insulator, said electric insulator forming either part or all of the first closed end of the reactor or positioned proximate thereto; (c) said first and second electrodes further separated by a gap and capable of generating and maintaining a gliding arc plasma discharge within a zone in said reactor upon application of an electric potential difference between the first and second electrodes; (d) said cylindrical wall having at least one feedstock injection portal, said feedstock injection portal capable of sustainably contacting an organic feedstock at the high temperature and configured to direct said feedstock tangentially into the plasma zone of said reactor; and (e) said cylindrical wall also having at least one air injection portal, said air injection portal positioned adjacent to the electrical insulator, said air injection portal configured to direct air tangentially into said reactor so as to shield the electrical insulator from the high temperature of the feedstock or plasma generated within the reactor, and to generate a vortex flow in the reactor and out the second open end.

Embodiment 2. The plasma reactor of Embodiment 1, said insulator forming the first closed end of the reactor shell and said second electrode penetrating therethrough and connected with a high voltage power supply.

Embodiment 3. The plasma reactor of Embodiment 1 or 2, wherein the electric insulator comprises a pefluoropolymer, preferably PTFE; including glass filled PTFE.

Embodiment 4. The plasma reactor of any one of Embodiments 1 to 3, the at least one feedstock injection portal configured to direct said feedstock tangentially into said reactor between the gap between the first and second electrodes.

Embodiment 5. The plasma reactor of any one of Embodiments 1 to 4, wherein the reactor further comprises a cylindrical diaphragm positioned in the gap between the first and second electrodes and distally in relation to the at least one feedstock injection portal, said diaphragm configured to promote fluid mixing within the reactor.

Embodiment 6. The plasma reactor of any one of Embodiments 1 to 5, wherein second elongated electrode is in the form of a concentric sleeve within the substantially cylindrical reactor wall.

Embodiment 7. The plasma reactor of any one of Embodiments 1 to 6, further comprising a fuel nozzle, an air atomizer, or both a fuel nozzle and air atomizer in fluid communication with the first closed proximal end, capable of injecting fuel, air, or both fuel and air axially into the reaction chamber.

Embodiment 8. The plasma reactor of any one of Embodiments 1 to 7, wherein the reactor further comprises a post-plasma zone positioned distally (downstream) from the plasma zone.

Embodiment 9. A method of operating the plasma reactor of any one of Embodiments 1 to 8, said method comprising: (a) providing air into the reactor through the air inlet portal at a rate sufficient to maintain the insulator at a temperature below a pre-defined threshold temperature, for example about 500° F. (about 260° C.); (b) providing feedstock tangentially into the plasma zone through the feedstock inlet portal; and (c) initiating a gliding arc plasma in the plasma zone between the first and second electrodes by the application of an electric potential difference across the first and second electrodes.

Embodiment 10. The method of Embodiment 9, wherein the first electrode is a ground electrode and the second electrode is a high voltage electrode

Embodiment 11. A plasma reactor for treating feedstocks at high temperature, said reactor comprising: (a) a substantially cylindrical outer shell having proximal and distal ends and configured to be positionable in-line to a tubular exhaust manifold, with the proximal end of the shell configured to be adjacent to and to receive the high temperature feedstock incoming from the tubular exhaust manifold; (b) a cupped first electrode having a open distal end facing away from the exhaust manifold, said first electrode positioned at or near the proximal end of the outer shell; (c) a substantially cylindrical second electrode having proximal and distal ends, the proximal end of the second electrode positioned adjacent to but separated from the distal end of the first electrode by a gap, said electrodes and gap configured to be capable of generating and maintaining a gliding arc plasma discharge within a plasma zone in said reactor upon application of an electric potential difference between the first and second electrodes; (d) the first electrode being physically attached to the proximal end of the outer shell by a first solid flange, said flange providing electrical communication between the first electrode and the outer shell and having a plurality of channels passing therethrough, said channels configured to direct the high temperature feedstock incoming from the exhaust manifold tangentially into the plasma zone; (e) the distal end of the second electrode physically attached the distal end of the outer shell by a second solid flange, said second flange comprising an electrical insulator capable of electrically isolating the second electrode from the outer shell; and (f) the outer shell, the second electrode, and the first and second flanges defining a substantially cylindrical annulus therebetween.

Embodiment 12. The plasma reactor of Embodiment 11, further comprising a third flange, said third flange comprising an electric insulator and attaching and electrically insulating the proximal end of the second electrode and the outer shell.

Embodiment 13. The plasma reactor of Embodiment 11 or 12, the high temperature feedgas having an incoming temperatures in a range of from about 600° to about 900° C., said reactor comprising materials of construction in a configuration capable of sustained contact between the reactor and the feedgas for at least 1000 consecutive hours.

Embodiment 14. The plasma reactor of any one of Embodiments 11 to 13, wherein the substantially cylindrical outer shell comprises ventilation holes to provide cooling to the second electrode.

Embodiment 15. The plasma reactor of any one of Embodiments 11 to 13, wherein the substantially cylindrical outer shell is a solid wall having at least one air inlet configured to be capable of providing cooling to the substantially cylindrical annulus upon delivery of air thereto.

Embodiment 16. The plasma reactor of Embodiment 14 or 15, wherein the cooling is sufficient to maintain the surface temperature of the insulator to less than about 500° F. (about 260° C.)

Embodiment 17. A method of operating the plasma reactor of any one of Embodiments 11 to 16, said method comprising: (a) providing cooling airflow through the cylindrical annulus; (b) providing the feedstock tangentially into the plasma zone through the feedstock channels; and (c) initiating a gliding arc plasma in the plasma zone between the first and second electrodes by the application of an electric potential difference across the first and second electrodes.

Embodiment 18. The method of Embodiment 17, the feedstock further comprising hydrogen, carbon monoxide, carbon dioxide, steam, light and heavy hydrocarbons, tar, air, oxygen, nitrogen, or a combination thereof.

Embodiment 19. A flow-through plasma reactor for treating high temperature feedstocks, said flow-through reactor comprising: (a) a reactor conduit through which a high temperature feedstock passes; and (b) at least two non-thermal plasma reactors, each reactor comprising at least one inlet circumferential gas flow inlet apparatus, an electrode, and a flow restricted exit portal; said non-thermal plasma reactors configured to eject a jet of non-thermal plasma, when energized, into said conduit so as to contact the high temperature feedstock with sufficient energy to remove heavy hydrocarbons and particulates from the passing high temperature feedstock.

Embodiment 20. The flow-through plasma reactor of Embodiment 19, wherein the at least two non-thermal plasma reactors are configured to work in tandem with one another such that a first reactor electrode can be maintained at a high voltage electric potential relative to a second reactor electrode, said first and second reactor electrodes forming an electrode pair capable of maintaining a non-thermal plasma discharge between the first and second reactor electrodes.

Embodiment 21. The flow-through plasma reactor of Embodiment 19 or 20, said flow-through plasma reactor further comprising: (a) a blower positioned within the reactor conduit downstream from the positions into which the at least two non-thermal plasma reactors are directed; and (b) at least one return conduit in fluid communication with the reaction conduit at a position downstream from the blower and at least one inlet apparatus of at least one non-thermal plasma reactors; such that the blower, when operating, reduces the pressure of the feedstock in a volume of the conduit between the at least two non-thermal plasma reactors and the blower, said reduced pressure causing gas to be redirected from the position downstream from the blower to the at least one inlet apparatus of at least one non-thermal plasma reactors.

Embodiment 22. A method of operating the flow-through plasma reactor of any one of Embodiments 19 to 21, said method comprising: (a) passing a high temperature feedstock stream through the reactor; and (b) providing sufficient energy to the at least two non-thermal plasma reactors to provide non-thermal plasma jets into the high temperature feedstock stream.

Embodiment 23. A method of operating the flow-through plasma reactor of Embodiment 21 or 22, said method comprising: (a) passing a high temperature feedstock stream through the reactor; (b) providing sufficient energy to the at least two non-thermal plasma reactors to provide non-thermal plasma jets into the high temperature feedstock stream; and (c) energizing the blower to blow downstream from the plasma jets so as to reduce the pressure of the feedstock in a volume of the conduit between the at least two non-thermal plasma reactors and the blower, so as to redirect a portion of the gas downstream from the blower to the at least one inlet apparatus of at least one non-thermal plasma reactors.

### EXAMPLES

The following Examples are provided to illustrate some of the concepts described within this disclosure. While each Example is considered to provide a specific individual embodiment of the invention, construction or use, none of the Examples should be considered to limit the more general embodiments described herein.

### Example 1

### Non-Thermal Plasma Conversion of Pyrolysis Gas Into Syngas

Experiments were conducted using a 10 kW high temperature plasma reformer, using an apparatus designed and shown schematically in FIG.2. The high voltage electrode and ground electrode of the plasma reformer were connected to a DC power supply. Omega FMA mass flow controllers were used to control the mass flow rates of the gases being directed to the plasma reformer. Experiments were carried out in the lab facility of Drexel Plasma Institute. Due to safety reasons the compressed air was used as a plasma gas and to cool electrical insulator. The plasma air was injected into reformer through the steel coil placed inside a controlled furnace to preheat it to operating conditions of industrial plant.

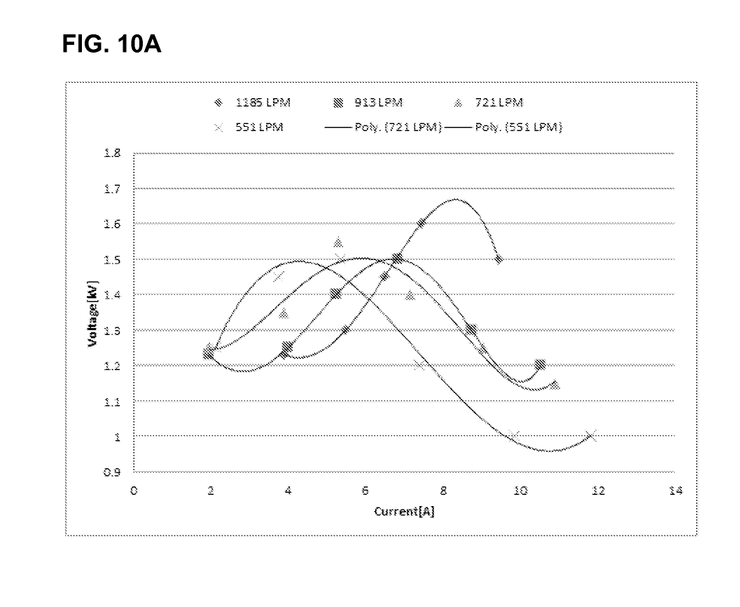

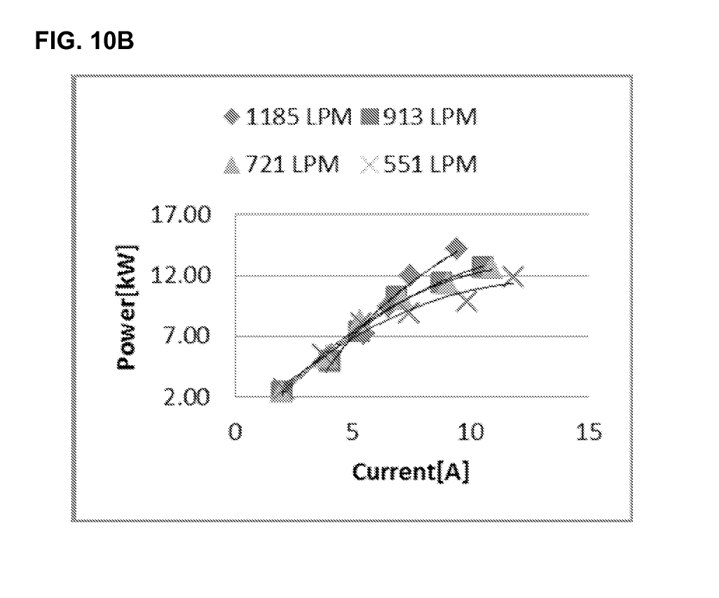

During testing the temperature of incoming to plasma region air maintained at 900° C. Additional cooling air injection was in the range between 25% and 31% of the overall flow. Plasma air flow rate varied between 551-1185 L/min; current was 2-10 A; produced plasma power was 2-14 kW. The produced operational characteristics of plasma reformer are presented at FIG. 10A and FIG. 10B.

Initial experiments were conducted wherein the PTFE electrical insulator (labeled “Insulator” in FIG. 2) was not protected by cooling air—i.e., the tangential air flow (“AIR”) to insulator surface was essentially zero). After approximately 15 minutes of operation, the plasma reformer failed due to short circuit between electrodes. After disassembling the reactor, it was determined that the cause of short circuit was melting of the PTFE insulator due to overheating.

A second set of experiments was then performed with constant air injection tangentially in the amount of 25% of total gas flow (i.e., air plus high temperature gas flow). After 4 weeks of operation at 4 hours continuously every day the plasma reformer was disassembled for visual inspection. There were no traces of soot deposition, melting or decay in the inner parts of plasma reformer. Also, the performance of gliding arc plasma reformer was the same during testing period indicating compliance of the developed plasma system to industrial standards.

As those skilled in the art will appreciate, numerous modifications and variations of the present invention are possible in light of these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

The disclosures of each patent, patent application, and publication cited or described in this document are hereby incorporated herein by reference, each in its entirety, for all purposes.

What is claimed:

1. A plasma reactor for treating feedstocks at high temperature, said reactor comprising:
(a) a substantially cylindrical reactor wall having a first closed proximal end and a second open distal end, wherein at least a portion of said wall is configured to comprise a first electrode;
(b) a second elongated electrode, electrically separated from the first electrode by an electrical insulator, said electric insulator forming either part or all of the first closed end of the reactor or positioned proximate thereto;
(c) said first and second electrodes further separated by a gap and capable of generating and maintaining a gliding arc plasma discharge within a zone in said reactor upon application of an electric potential difference between the first and second electrodes;
(d) said cylindrical wall having at least one feedstock injection portal, said feedstock injection portal capable of sustainably contacting an organic feedstock at the high temperature and configured to direct said feedstock tangentially into the plasma zone of said reactor; and
(e) said cylindrical wall also having at least one air injection portal, said air injection portal positioned adjacent to the electrical insulator, said air injection portal configured to direct air tangentially into said reactor so as to shield the electrical insulator from the high temperature of the feedstock or plasma generated within the reactor, and to generate a vortex flow in the reactor and out the second open end.

2. The plasma reactor of claim 1, said insulator forming the first closed end of the reactor shell and said second electrode penetrating therethrough and connected with a high voltage power supply.

3. The plasma reactor of claim 1, wherein the electric insulator comprises a pefluoropolymer, preferably PTFE; including glass filled PTFE.

4. The plasma reactor of claim 1, the at least one feedstock injection portal configured to direct said feedstock tangentially into said reactor between the gap between the first and second electrodes.

5. The plasma reactor of claim 1, wherein the reactor further comprises a cylindrical diaphragm positioned in the gap between the first and second electrodes and distally in relation to the at least one feedstock injection portal, said diaphragm configured to promote fluid mixing within the reactor.

6. The plasma reactor of claim 1, wherein second elongated electrode is in the form of a concentric sleeve within the substantially cylindrical reactor wall.

7. The plasma reactor of claim 1, further comprising a fuel nozzle, an air atomizer, or both a fuel nozzle and air atomizer in fluid communication with the first closed proximal end, capable of injecting fuel, air, or both fuel and air axially into the reaction chamber.

8. The plasma reactor of claim 1, wherein the reactor further comprises a post-plasma zone positioned distally (downstream) from the plasma zone.

9. A method of operating the plasma reactor of claim 1, said method comprising:
(a) providing air into the reactor through the air inlet portal at a rate sufficient to maintain the insulator at a temperature below a pre-defined threshold temperature, for example about 500° F. (about 260° C.);
(b) providing feedstock tangentially into the plasma zone through the feedstock inlet portal; and
(c) initiating a gliding arc plasma in the plasma zone between the first and second electrodes by the application of an electric potential difference across the first and second electrodes.

10. The method of claim 9, wherein the first electrode is a ground electrode and the second electrode is a high voltage electrode

11. A plasma reactor for treating feedstocks at high temperature, said reactor comprising:
(a) a substantially cylindrical outer shell having proximal and distal ends and configured to be positionable in-line to a tubular exhaust manifold, with the proximal end of the shell configured to be adjacent to and to receive the high temperature feedstock incoming from the tubular exhaust manifold;
(b) a cupped first electrode having a open distal end facing away from the exhaust manifold, said first electrode positioned at or near the proximal end of the outer shell;
(c) a substantially cylindrical second electrode having proximal and distal ends, the proximal end of the second electrode positioned adjacent to but separated from the distal end of the first electrode by a gap, said electrodes and gap configured to be capable of generating and maintaining a gliding arc plasma discharge within a plasma zone in said reactor upon application of an electric potential difference between the first and second electrodes;
(d) the first electrode being physically attached to the proximal end of the outer shell by a first solid flange, said flange providing electrical communication between the first electrode and the outer shell and having a plurality of channels passing therethrough, said channels configured to direct the high temperature feedstock incoming from the exhaust manifold tangentially into the plasma zone;
(e) the distal end of the second electrode physically attached the distal end of the outer shell by a second solid flange, said second flange comprising an electrical insulator capable of electrically isolating the second electrode from the outer shell; and
(f) the outer shell, the second electrode, and the first and second flanges defining a substantially cylindrical annulus therebetween.

12. The plasma reactor of claim 11, further comprising a third flange, said third flange comprising an electric insulator and attaching and electrically insulating the proximal end of the second electrode and the outer shell.

13. The plasma reactor of claim 11, the high temperature feedgas having an incoming temperatures in a range of from about 600° to about 900° C., said reactor comprising materials of construction in a configuration capable of sustained contact between the reactor and the feedgas for at least 1000 consecutive hours.

14. The plasma reactor of claim 11, wherein the substantially cylindrical outer shell comprises ventilation holes.

15. The plasma reactor of claim 11, wherein the substantially cylindrical outer shell is a solid wall having at least one air inlet configured to be capable of providing cooling to the substantially cylindrical annulus upon delivery of air thereto.

16. The plasma reactor of claim 15, wherein the cooling is sufficient to maintain the surface temperature of the insulator to less than about 500° F. (about 260° C.)

17. A method of operating the plasma reactor of claim 11, said method comprising:
(a) providing cooling airflow through the cylindrical annulus;
(b) providing the feedstock tangentially into the plasma zone through the feedstock channels; and
(c) initiating a gliding arc plasma in the plasma zone between the first and second electrodes by the application of an electric potential difference across the first and second electrodes.

18. The method of claim 17, the feedstock further comprising hydrogen, carbon monoxide, carbon dioxide, steam, light and heavy hydrocarbons, tar, air, oxygen, nitrogen, or a combination thereof

19. A flow-through plasma reactor for treating high temperature feedstocks, said flow-through reactor comprising:
(a) a reactor conduit through which a high temperature feedstock passes; and
(b) at least two non-thermal plasma reactors, each reactor comprising at least one inlet circumferential gas flow inlet apparatus, an electrode, and a flow restricted exit portal, said non-thermal plasma reactors configured to eject a jet of non-thermal plasma, when energized, into said conduit so as to contact the high temperature feedstock with sufficient energy to remove heavy hydrocarbons and particulates from the passing high temperature feedstock.

20. The flow-through plasma reactor of claim 19, wherein the at least two non-thermal plasma reactors are configured to work in tandem with one another such that a first reactor electrode can be maintained at a high voltage electric potential relative to a second reactor electrode, said first and second reactor electrodes forming an electrode pair capable of maintaining a non-thermal plasma discharge between the first and second reactor electrodes.

21. The flow-through plasma reactor of claim 19, said flow-through plasma reactor further comprising:
(a) a blower positioned within the reactor conduit downstream from the positions into which the at least two non-thermal plasma reactors are directed; and
(b) at least one return conduit in fluid communication with the reaction conduit at a position downstream from the blower and at least one inlet apparatus of at least one non-thermal plasma reactors;
such that the blower, when operating, reduces the pressure of the feedstock in a volume of the conduit between the at least two non-thermal plasma reactors and the blower, said reduced pressure causing gas to be redirected from the position downstream from the blower to the at least one inlet apparatus of at least one non-thermal plasma reactors.

22. A method of operating the flow-through plasma reactor of claim 19, said method comprising:
(a) passing a high temperature feedstock stream through the reactor; and
(b) providing sufficient energy to the at least two non-thermal plasma reactors to provide non-thermal plasma jets into the high temperature feedstock stream.

23. A method of operating the flow-through plasma reactor of claim 21, said method comprising:
(a) passing a high temperature feedstock stream through the reactor;
(b) providing sufficient energy to the at least two non-thermal plasma reactors to provide non-thermal plasma jets into the high temperature feedstock stream; and
(c) energizing the blower to blow downstream from the plasma jets so as to reduce the pressure of the feedstock in a volume of the conduit between the at least two non-thermal plasma reactors and the blower, so as to redirect a portion of the gas downstream from the blower to the at least one inlet apparatus of at least one non-thermal plasma reactors.
